(19) United States
(12) Patent Application Publication
(10) Pub. No.: US 2004/0208321 A1
(43) Pub. Date: Oct. 21, 2004

(54) Method for the generation of pseudo-random permutation of an N-digit word

(76) Inventor: Jean-Philippe Wary, Bourg La Reine (FR)

Correspondence Address: PERMAN & GREEN, 425 POST ROAD, FAIRFIELD, CT, 06824, US

(21) Appl. No.: 10/772,798

(22) Filed: Feb. 5, 2004

(30) Foreign Application Priority Data
Feb. 27, 2003 (FR) 03 50038

(51) Int. Cl. H04L 9/00

(52) U.S. Cl. 380/268

(57) ABSTRACT

A method for the generation of small permutations on digits, for example between 7 and 30 digits, uses basic functions that are classic, one-way functions (generally non-bijective) defined on bits, and uses these functions in a generalized Feistel scheme that has at least five rounds.

### BACKGROUND OF THE INVENTION

1. Field of the Invention

An object of the invention is a method for the pseudo-random computation of a permutation of a word comprising N digits. The field of the invention is that of cryptography. More particularly, the field of the invention is that of cryptography applied to the encryption of words formed by digits.

It is an aim of the invention to enable the robust encryption of a word formed by N digits, N being contained in the interval [7, 30].

It is another aim of the invention to provide a fast encryption of a word formed by N digits, N being contained in the interval [7, 30].

It is another aim of the invention to determine a robust pseudo-random permutation in a set whose cardinal is 10^{N}; this cardinal is therefore not a power of 2.

It is another aim of the invention to perform the enciphering of identifiers based on the use of digits, such as for example telephone numbers.

It is another aim of the invention to generate a string of N digits that is a pseudo-random string, i.e. for a person who does not know the secret key that is used to generate this string, this string, in practice, cannot be distinguished from a truly random string.

It is another aim of the invention to produce N-digit strings such that the production process ensures that the same string will not be produced twice.

2. Description of the Prior Art

In the prior art, the term “bit” is understood to mean a variable that can take the value 0 or the value 1. These two values are physically represented, in a computer or memory by an electrical signal that can take two values, one associated with 0 and the other associated with 1. A binary word is an ordered succession of bits.

A digit is a variable that can take one of the following values 0, 1, 2, 3, 4, 5, 6, 7, 8, 9. A digit can be encoded by bits. In this case, then, each digit has a corresponding binary word. This binary word is generally four bits long but it may also be a word with a length of eight bits (ASCII code) or more. A word in digits or digit word is an ordered succession of digits.

A permutation is a bijection or one-to-one and on-to mapping on a finite set.

A <<pseudo-random permutation>> is a permutation generated by a computer program that is fairly simple to compute from a secret key K having the following property: a person who does not known the key K is in practice incapable of distinguishing a permutation of this kind from a truly random permutation (with the same input and output sizes), because the number of computations needed in order to distinguish them by known methods far exceeds what is possible in realistic terms.

At present, if we consider the fact that 2⁸⁰ elementary computations (or more) are needed to resolve a problem, this number of computations is excessively great for any intruders.

In the prior art, there are known permutations in sets wherein the number of elements is a power of 2. There are also known attempts to adapt these permutations to sets wherein the number of elements is not a power of 2. Such a technique, used to encipher the elements of a set E comprising n elements, consists in using a permutation P working on a subset SE of E comprising a number of elements that is a power of 2. To determine Ck(x), i.e. the encryption of x belonging to E with the key k, the operation starts with the computation of the n-tuple V, with

V={Pk(i)}, where i describes E.

Since all the elements of V are different, an n-tuple W is produced by replacing each element of V by the rank of this element in oV, where oV is the ordered n-tuple V. Then, it is obtained that Ck(x) is the xth element of W.

One drawback of this method is that to encipher/decipher a word, it is necessary to encipher/decipher all the words of the initial set. This leads to lengthy and costly computation times. Indeed, such computations take a great deal of time, thus reducing the response times of a server, in a client-server application. If the customer is an autonomous, portable apparatus such as a mobile telephone and if the customer has to implement such a method, the problem is even greater since the customer has less computation power than a server.

Another known method for carrying out a permutation of a set E comprising a number of elements that is not a power of 2 is to consider a subset SE of E, where SE comprises a number of elements that is a power of 2, and a permutation P of the set SE. Then Ck(x), i.e. the enciphering of x for a key k, is obtained for the following recursive algorithm:

Algorithm Ck(x)

y=Pk(x)

if y is in E then send y

else send on Ck(y)

end

The weakness of this method lies in the convergence time of the algorithm used. Indeed, it may happen that it is necessary to make many computations and, in this case, the computation time becomes excessively costly.

In the prior art, there are other known enciphering solutions not based on permutations, i.e. not based on bijection. However, inasmuch as it is sought co carry out a reversible encryption, it must be ensured that the result of an enciphering is unique. Thus, at present, in certain applications, in order to ensure the uniqueness of the enciphering, certain industrialists or operators have, for many years, being been storing all the digit strings generated. They may thus ensure that each string is new because, if they generate an already used string, they detect it and do not put this string into circulation again but generate another string. However, such a method is costly and proves in the long run to be inconvenient because it soon calls for a great deal of available memory space and large and quickly accessible backup means located in highly secured premises. Furthermore, the number of computations to be made increases with the number of values already generated, and therefore increases with time.

In particular, these three solutions do not perform well as regards the generation of permutations on credit card or telephone type numbers. Indeed, the number of computations to be made may be excessively costly and cryptographic security may not be ensured. Instead of these three solutions, it is possible to use a generator of pseudo-random permutations on the digits, as shall be described. The fact that twice the same value is not generated will be ensured by the bijective character of the generator (it generates permutations).

At present, all the standard cryptographic functions, in secret key cryptography, take a certain number of bits at input and give a certain number of bits at output. This is the case, for example, of the SHA-1 function, the DES function, the AES function etc. Now, in certain industrial-scale applications, for example in telephony, it is sought to have not a certain number of bits but a certain number of digits at input and output. For this purpose, one solution would be to rewrite specific functions, but designing and developing these functions could take up a lot of time, and they would necessarily be far less analyzed by the international cryptographic community. Or else, according to the invention, it is possible to have inputs and outputs on the digits, but ones that use classic cryptographic functions on the bits to ensure security. It is such a method, for a particular problem, that is implemented here.

For a better understanding of the subject and object of the present invention, a few points regarding the Feistel schemes are briefly recalled herein.

Let n be a natural integer. Let Iₙ={0, 1}ⁿ be the set of strings of n bits.

Let f₁ be any function of Iₙ towards Iₙ.

Let G and D be two elements of Iₙ.

[G, D] denotes the element of I₂ₙ whose n first bits are equal to G, and the n following bits are equal to D.

ψ(f₁) denotes the bijection of I₂ₙ towards I₂ₙ such that: for any [G, D] of I₂ₙ, and for any [U, V] of I₂ₙ, W(f₁)[G,D]=[U, V] if and only if:

S=DetT=G⊕f₁(D),

where ⊕ designates the <<XOR>> operation (or bit to bit modulo 2 operation).

ψ(f₁) is truly a bijection, for the inverse function is the function g such that:

g[U,V]=[T⊕f₁(S),S]=[G,D].

Finally, since T is an integer that will be called the number of rounds of the Feistel scheme, and since f₁, f₂, . . . f_{T} are T functions of Iₙ to Iₙ, which will be called the T round functions, ψ(f₁, f₂, . . . f_{T}) denotes the next bijection of I₂ₙ to I₂ₙ:

ψ(f₁,f₂, . . . f_{T})=ψ(f_{T}) . . . ∘ψ(f₂)∘ψ(f₁),

where ú∘ designates the law of composition of the functions.

The bijection ψ(f₁, f₂, . . . f_{T}) is called a <<T round Feistel scheme>>.

A definition shall now be given of what is called a generalized Feistel scheme. The idea that underlies this form, which is different from the Feistel scheme, is the following. Instead of dividing the word into two equal parts of n bits in order to obtain 2n bits, it is possible, more generally, at each round, to cut it into one part comprising a bits, and another part comprising b bits, with a+b=N (N being in this case the total number of input and output bits). It is also possible to make a and b vary according to the round number I; the values of a and b varying according to the rounds will be denoted by aᵢ and bᵢ. What is known as a generalized Feistel scheme is then obtained. This definition may be specified as below:

n being any natural integer, Iₙ={0, 1}ⁿ always denotes the set of n-bit strings.

Let a, b and n be three natural integers such that: a+b=n.

Let f₁ be any function from I_{b} to Iₐ.

Let G be an element of Iₐ, and D and element of I_{b}.

[G, D] denotes the element of Iₙ for which the first a bits are equal to G, and the following b bits are equal to D.

ψ′(f₁) denotes the bisection from Iₙ to Iₙ such that: for any [G, D] of Iₙ, and for any [U, V] of Iₙ, ψ′(f₁)[G, D]=[U, V] if and only if:

U=G≠f₁(D), and V=D

where ⊕ designates the <<XOR>> operation (or bit by bit modulo 2 addition).

And λ being the function that makes a rotation on the bits of a bits (the new first bit is the old (a+1)^{th} bit, the new second bit is the old (a+2)^{th} bit etc.), the following is written:

ψ(f₁)=λ∘ψ′(f₁)

Finally, T being an integer which shall be called the number of rounds of the generalized Feistel scheme, and fᵢ, 1≦i≦T, being T functions from I_{bi} to Iₐᵢ, which shall be called the T round functions, ψ(f₁, f₂, . . . f_{T}) denotes the following bijection of I₂ₙ to I₂ₙ:

ψ(f₁,f₂, . . . f_{T})=ψ(f_{T}) . . . ∘ψ(f₂)∘ψ(f₁),

where ∘ designates the law of composition of the functions.

The bijection ψ(f₁, f₂, . . . f_{T}) is called a <<generalized T-round Feistel scheme>>.

It is also possible here to envisage particular cases of generalized Feistel schemes, for example alternating a bits and b bits. Thus, it is also possible to alternate functions that change a bits, and functions that change b bits as presented here below.

Thus, for example, at every odd-valued round, it is possible to have a transformation of the following type:

ψ(fᵢ)[G,D]=[U,V] if and only if:

U=G⊕fᵢ(D) et V=D, where fᵢ is a function of I_{b} towards Iₐ,

and at every even-valued round, it is possible to have a transformation of the type:

ψ(fⱼ)[G,D]=[U,V] if and only if:

U=G and V=D⊕fⱼ(G), where fⱼ is a function of Iₐ to I_{b}.

In the invention, these problems are resolved by using a generalized Feistel scheme. The generalized Feistel scheme used is a scheme comprising at least five rounds and, in a preferred example, six rounds. However, greater resistance to cryptographic analysis is sometimes obtained with a greater number of rounds. Thus, it is possible to go up to 30 rounds to remain within computation times compatible with response times of a system implementing the invention. The round functions of the generalized Feistel scheme take a digits at input and give b digits at output. They are made as follows, it being known that these functions must work on binary words:

1. A binary word A is computed from these b digits, a key K and a round number i; here, for example, it is a simple conversion of the concatenation of these values into binary mode,

2. B=f(A) is computed, f being a one-way function on bits; this step is generally the step most important for security, owing to the one-way character of the function f,

3. C=g(B) is computed, g being a function that takes a binary word at input and gives a word comprising a digits at output. This is, for example, a simple conversion into digits of a binary word; often, a function f will be taken for the step 2 such that B has exactly the format adapted to a direct conversion of this kind.

Thus, the round function output binary words are transformed into digits. Such a round function is based, for example, on the hash algorithm SHA-1 (Secure Hash Algorithm). This construction gives a pseudo-random function in a set of elements formed by digits. The permutation, namely the bijective character, is guaranteed by construction, by the use of a Feistel scheme. The pseudo-random aspect, for its part, is guaranteed because no known cryptographic attack can be successfully launched against this mode of encryption since at least five rounds are used here.

### SUMMARY OF THE INVENTION

An object of the invention therefore is a method for the generation of a pseudo-random permutation of an N-digit word in which:

a generalized Feistel scheme (202-205) is implemented, wherein:

the round functions of the generalized Feistel scheme implemented are functions (Fi) such that:

the input words of the round functions are produced by the conversion of digit words into binary words,

then a one-way function is applied to these binary words,

finally, the output in digits is a function of these binary words.

a digit word to be enciphered is read in a memory (104),

the generalized Feistel scheme used comprises at least T=5 rounds.

### BRIEF DESCRIPTION OF THE DRAWINGS

The invention will be understood more clearly from the following description and from the accompanying figures. These figures are given purely by way of an indication and in no way restrict the scope of the invention. Of these figures:

FIG. 1 illustrates means useful for the implementation of the method according to the invention;

FIG. 2 illustrates steps of the method according to the invention.

### MORE DETAILED DESCRIPTION

In general, the actions described are undertaken by a device comprising a microprocessor and a memory comprising instruction codes to command this microprocessor. These instruction codes correspond to the implementation of the steps of the method according to the invention. A word, whether binary or in digits, is an electrical representation or again an electrical signal, or a variable in a memory or a register. When an action is attributed to an apparatus, this action is performed by a microprocessor of this apparatus controlled by instruction codes recorded in a memory of this apparatus.

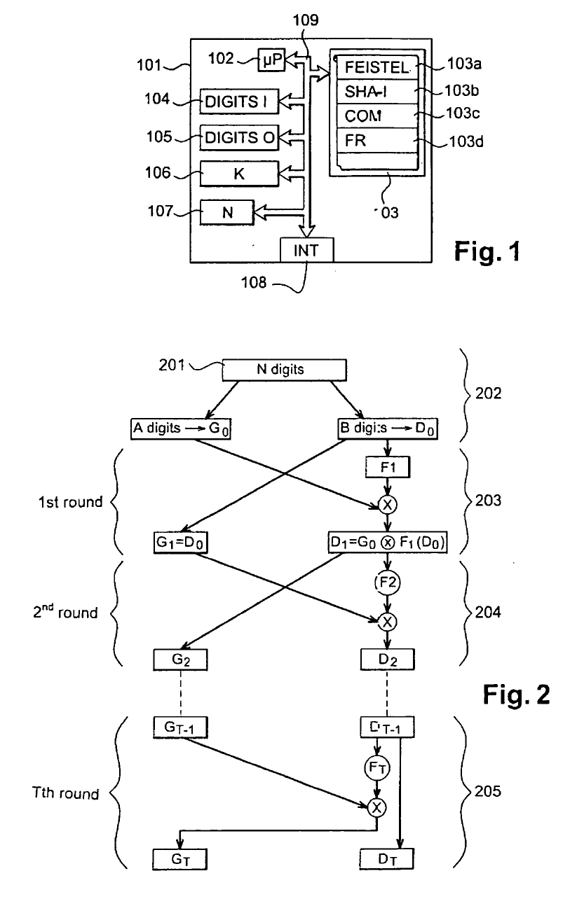

FIG. 1 shows an apparatus 101 implementing the method according to the invention. The steps of the method according to the invention are therefore implemented by the apparatus 101. Such an apparatus is, in practice, the server of an operator of a telecommunications network. However, the method according to the invention can be implemented by any device or system corresponding to FIG. 1. Examples of apparatuses that can implement the method according to the invention include a mobile telephone, a personal assistant, a computer whether it is laptop, desktop or a rack computer. This list is not exhaustive.

FIG. 1 shows that the apparatus 101 has a microprocessor 102, a program memory 103, a memory 104 of input digit words, a memory 105 of output digit words, a key memory 106, a memory 107 of the number of rounds, and interface circuits 108. The elements 102 to 108 are interconnected by a bus 109.

In FIG. 1 the memories 103 to 107 are represented as separate memories. In practice, these memories may very well be one and the same memory component, or a memory component and registers of a specialized circuit (ASIC).

The memory 104 enables the recording of a digit word that must be enciphered/encrypted by the method according to the invention. The memory 105 enables the recording the result of the enciphering, by the method according to the invention, of the word recorded in the memory 104. The memory 106 enables the recording of a key used by the enciphering method according to the invention. The memory 107 enables the recording of the number of rounds of the Feistel scheme/network according to the invention.

The memory 103 is divided into several zones corresponding to different functions implemented by the microprocessor 102. A zone 103a has instruction codes corresponding to the implementation of a Feistel scheme. A zone 103b comprises instruction codes corresponding to the implementation of a hash function, in the present example SHA-1. A zone 103c corresponds to the implementation of communications functions, especially the instruction codes of the zone 103c enabling the control of the circuits 108. A zone 103d comprises instruction codes for the implementation of a round function.

The memory 103 has other working and storage zones not shown in FIG. 1.

The circuits 108 connect the apparatus 101 to external devices such as a network, a keyboard and a screen. It is through these circuits 108, and the instruction codes of the zone 103c, that it is possible to read and/or write in the memories 104 to 107 which are also memories for the parametrization/configuration of the method according to the invention.

FIG. 2 illustrates the working of a generalized Feistel scheme according to the invention. FIG. 2 shows a preliminary step 201 in which the user enters the digit word to be enciphered. This entry consists in writing the digit word M to be enciphered in the memory 104. In the step 201, the user also enters information into the contents of the key memory 106, as well as the contents of the memory 107 of the number of rounds. These circuits are updated through the circuits 108.

There is then a passage to the first step of the enciphering method proper. This is a step 202 for subdividing and converting the digit word M into binary words G0 and D0. This subdivision is such that M=[G0, D0]. By construction and definition, G0 is the left-hand part of M and D0 is the right-hand part of M. It shall be considered, for example, that M has 10 digits, i.e. that N is equal to 10. In the case of a standard Feistel scheme, the word to be enciphered is subdivided into two parts of equal length. We shall discuss the generalized Feistel scheme further below. In the present example, G0 and D0 are therefore binary words, each corresponding to five digits. In this example, we therefore have A=B=5, where A is the length in digits of the word G0, and B is the length in digits of the word D0.

A digit word is a binary representation in memory. This representation is, most of the time, a sequence of quartets or nybbles (4-bit units), or respectively a sequence of eight-bit bytes (eight bits, for the ASCII code). Each quartet or eight-bit byte respectively then corresponds to a digit. If we consider the case of the use of a quartet, in a known way, the conversion of a digit word into a binary word is done simply by the juxtaposition of the binary words corresponding to each digit. Thus 0 corresponds to the quartet 0000, 1 to the quartet 0001, 2 to the quartet 0010 and so on and so forth until 9 which corresponds to the quartet 1001. With this mode of encoding, the binary conversion, for example of the digit word 12345, is the binary word 00010010001101000101 formed by five quartets.

There is another way of converting a digit word into a binary word. This other way is that of the preferred embodiment of the invention. In this other way of conversion, a digit word is converted by using a binary word having the same decimal value as the digit word read. Thus, the digit word 12345 is converted into a binary word corresponding to their decimal value, namely the binary word 11000000111001.

At the end of the step 202, the digit word M is subdivided into two binary words G0 and D0. For example, if the word in digits is 1234567890, then G0 is the conversion in binary form of 12345, and D0 is the conversion in binary form of 67890. The method then passes to a step 202 or first round of the Feistel scheme according to the invention.

In the step 202, a binary word G1 is computed. This word G1 is actually equal to D0. A binary word D1 is also computed such that D1=G0⊕F1(D0). In this expression, the symbol ⊕ corresponds to an exclusive-or or “XOR” function. The function F1 is the round function of the first round of the Feistel scheme according to the invention. Generally, Fi denotes the round function of the ith round of the Feistel scheme according to the invention. The function Fi is expressed for example as follows:

Fi(x)=<SHA_{—}1(i∥K∥×∥j)> (1)

In this expression SHA_{—}1( ) is the hash function of the same name. In practice, another hash algorithm such as MD5 for example may be used. It is also possible to use another function such as AES (Advanced Encryption Standard) or TDES (Triple Data Encryption Standard). These are standard pseudo-random functions of cryptography on binary words. More generally, it is possible to use any function or a pseudo-random function on bits.

∥ is a concatenation operator, K is the key that is read in the memory 106, i is the index of the round of the Feistel function. The notation <∥j> signifies that j is initialized at 0, and then that the 17 most significant bits are extracted from the output of the function SHA_{—}1. If these 17 bits correspond precisely to five digits, this output is kept. If not j is increased by one unit and the expression (1) is re-evaluated until this property is obtained. This iteration on j actually corresponds to a conversion of a binary number into a digit number. The input words of the round functions are therefore produced by the conversion of the digit words into binary words. The output binary words of the round functions are therefore converted into digit words. In order that 17 bits may correspond precisely to five digits, the conversion of this 17-bit word into decimal notation must be expressed with five figures.

The fact that 17 bits are extracted is related to the fact that the work is done with words having a length of five digits. More particularly, this is related to the fact that the round function considered produces a five-digit word. In practice, the number of extracted bits is related to the length of the word in digits produced by the following consideration: the number of bits extracted corresponds to the length of a binary word enabling the encoding of the greatest decimal value that can be represented with the number of digits of the word produced. Thus, with five digits, the greatest decimal value that can be represented is 99 999. 17 bits are needed to encode this value in binary mode. If we consider, for example, a seven-digit word, then the greatest decimal value that can be represented is 9 999 999. In this case, it is necessary to extract 24 bits. This reasoning can be applied to any number of digits.

In one variant, the iteration on j stops as soon as the extracted bits correspond to a decimal value that can be represented by the number of digits to be produced by the round function.

It is recalled here that the words processed have a length of five digits for the word M has a length of 10 digits, and that it has been separated into two words of five digits each.

The function described by the expression (1) is non-reversible, i.e. it is a one-way function for it implements a hash function which is itself non-reversible. The term “non-reversible” means that it is impossible to determine the input of a function by knowing its output. In general, the irreversibility of the round function is related to the fact that a certain number of bits is extracted from its output, and that it therefore cannot be a bijection.

At the end of the step 203, there is therefore a word M1=[G1, D1]. The invention then passes to a step 204 for the computation of a word M2=[G2, D2] with G2=D1, and D2=G1⊕F2(D1). The step 204 is the second round of the Feistel scheme according to the invention. The step 204 is identical to the step 203 except that the step 204 works on the word M1 while the step 203 works on the word M.

In general, in a Feistel scheme, the ith round produces a word Mi=[Gi, Di] with Gᵢ=Dᵢ₋₁, and Dᵢ=Gᵢ₋₁⊕Fᵢ(Dᵢ₋₁).

In the present example, we consider a five-round Feistel scheme. Hence T is equal to 5. Thus, after the step 204 the third and fourth rounds are performed as described for the general case.

During the Tth round, in this case the fifth round, and the step 205, a word M_{T}=[G_{T}, D_{T}] is produced, with GT=G_{T-1}⊕F_{T}(D_{T-1}), and D_{T}=G_{T-1}. The word M_{T} can thus be used as an input of the Feistel scheme with the key K and the initial word M will be retrieved at output. The word M_{T} is the result of the enciphering of the word M by the method according to the invention. At the end of the step 205, the word M_{T} is written in the memory 105. In a summary writing of the method of the invention, the following is written:

M_{T}=Chi(M,K,T)

This expression must be read as follows: M_{T} is the result of the enciphering (Chi) of M by the method according to the invention with the key K, and a number of rounds equal to T. The deciphering function is then the same, and we have:

M=Chi(M_{T,K,T)}

The memory 105 is read through the circuits 108, enabling the result of the enciphering to be used.

In the present example, the Feistel scheme comprises T=five rounds. In a preferred mode of implementation, the Feistel scheme comprises six rounds. In practice, it is possible to go up to 30 rounds. However, it is necessary to be able to attain a compromise with speed of execution. Indeed, the greater the number of rounds, the greater the increase in computation time. In practice, six rounds are enough to avert all known attacks that are not based on brute force. With the computation power now available, it is possible to go up to 30 rounds without appreciably impairing the response time of a system implementing the method according to the invention. In practice, the number of rounds T is therefore smaller than 30.

In the exemplary description, the word M is deemed to comprise 10 digits. In practice, the word M may comprise an odd number of digits. In practice again, it is possible to carry out a non-symmetrical division of the word M. In both these cases, a generalized Feistel scheme is implemented, i.e. A is different from B. It is noted that the case A=B is a particular case of the generalized scheme.

Let it be considered, for example, that M comprises N=11 digits. Let it then be considered that A is equal to 5 and B is equal to 6. We have N=A+B. We also have G0 with a length of five digits and D0 has a length of six digits. At the end of the first round of the generalized Feistel function, we have G1=D0 comprises six digits, and D1=G0⊕F1(D0) comprises five digits. In this case, the function F1 works on a word with a length of six digits to produce a word with a length of five digits and therefore 17 bits are extracted from the output of the function SHA_{—}1, as described here above.

At the end of the second round of the Feistel scheme, we have G2=D1, comprises five digits. We also have D2=G1⊕F2(D1) comprises six digits. In this case, the function F2 works on a word with a length of five digits to produce a word with a length of six digits. Hence 20 bits are extracted from the output of the function SHA_{—}1 according to the considerations already seen.

In the case of a generalized Feistel scheme, the subdividing of the word to be enciphered is not symmetrical. The round functions therefore do not work on the same number of digits depending on whether the index of the round is an even value or an odd value. Thus, during rounds with an odd-valued index, the round function of the Feistel scheme works on a word with a length of B digits to produce a word with a length of A digits. During rounds with an even-valued index, the round function of the Feistel scheme works on a word with a length of A digits to produce a word with a length of B digits.

In general, A and B can take any values so long as A+B=N. It is preferred to subdivide a digit word symmetrically. Should N be an even-parity value, this poses no problem. We have A=B=N/2. Should N be an odd-parity value, it is stated then that A is equal to the integer part of N/2, while B is equal to N−A. Thus we truly have A+B=N. With this mode of subdivision, B is never greater than A by more than one unit. We thus have an integer subdivision that is as close as possible to a symmetrical subdivision.

This enciphering method is used to encipher commonly used digit words. Such words are telephone numbers (8 to 10 digits), visa card numbers (16 digits), social security numbers (13 digits in France), bank account numbers, electronic vouchers, etc: the list is not exhaustive. Furthermore, these numbers may be concatenated into a greater number so as to obtain a 30-digit word.

In general, with the method according to the invention, the longer the word to be enciphered, i.e. the greater the length of N, the greater the resistance to cryptographic analysis.

For an input word, a given enciphering key and a number of rounds of the Feistel scheme, it is always the same enciphered word that is obtained. So as to reinforce the enciphering and, above all, to prevent behavioral research based on an electronic identifier, a digit number to be enciphered can be concatenated with a random digit number. For example, to encipher a telephone number, it is first concatenated with the number of seconds that have elapsed since the beginning of the current hour. Then the result of this concatenation is enciphered. Thus, the same enciphered word is only obtained very rarely for a given telephone number. The type of random number used is any random number. It may be obtained, for example, by means of a simple counter of a number drawn from a pre-computed pseudo-random sequence, the counter increasing with each instance of use. This list is not exhaustive.

Thus, among the possible uses of the method according to the invention, there is the possibility of enciphering information between the sender of this information and its addressee. There is also the possibility of isolating two networks from each other. This isolation is achieved, for example, by a server of the operator of a first network. With the method according to the invention, this server transcodes an identifier of the first network to produce an identifier on the second network. Thus, the entities acting on the second network, except for the operator of the first network, are incapable of identifying the user of the first network.

The invention can therefore be applied very particularly and very advantageously to telephony. Thus, in the context of protecting the privacy of subscribers with a telephony operator and combating spam, all the protocols use the MSISDN (the subscriber's international telephone number) encoded on 15 digits as a subscriber identifier and this information could then be misused by the service provider in order to set up a user profile or send spam type messages. It may be sought to conceal this value by enciphering but the result must then be compatible with the format of the telecommunications protocols. In particular, the operator should be capable of easily deciphering this value. These two aims are achieved with the method according to the invention.

The case of the electronic voucher is also a good exemplary application of the invention. The interface at the level of a mobile telephone is limited to the numerical keypad. The user is therefore limited in his keying-in operation to digits. In the generation of an electronic voucher (a voucher number is equivalent to a financial value, for example 30 euros), each keying in of a voucher is used to credit a sum to an account. The management of the vouchers with the service provider is simplified if the generator of these values uses symmetrical algorithms working on digits. A counter runs from 1 to M, and the enciphering of the counter gives pseudo-random data that are all different. It is thus possible to generate pseudo-random codes on N digits, easily manageable by the service provider because it is only the last counter value used that is stored and not all the values of vouchers already generated to ensure the uniqueness of these vouchers.

In general, in “large” databases, the storage is done in unencrypted form. The structure may be composed (with digital and alphanumerical non-homogeneous formats) and the safety requirements dictate enciphering. In this case too, digital enciphering enables the efficient protection of the data, and this is achieved without any modification of the structure and for at very low cost in economic terms.

These exemplary modes of implementation of the invention do not limit the fields of application of the invention.

1. A method for the generation of a pseudo-random permutation of an n-digit word in which:
a generalized Feistel scheme is implemented, wherein:
the round functions of the generalized Feistel scheme implemented are functions (Fi) such that:
the input words of the round functions are produced by the conversion of digit words into binary words,
then a one-way function is applied to these binary words,
finally, the output in digits is a function of these binary words.
a digit word to be enciphered is read in a memory,
the generalized Feistel scheme used comprises at least T=5 rounds.

2. A method according to claim 1, wherein the one-way function on the binary words uses a standard pseudo-random cryptography function on binary words.

3. A method according to claim 1 wherein the standard pseudo-random function on the binary words uses the SHA-1 function.

4. A method according to claim 1 wherein the number of rounds T of the Feistel heme is smaller than or equal to 30.

5. A method according to one of the claims claim 1, wherein the number of rounds T of the Feistel heme is equal to 6.

6. A method according to claim 1 wherein, during odd-valued rounds of the Feistel scheme, the round function works on a word with a length B, and during even-valued rounds of the Feistel scheme it works on words with a length of A digits, where A+B=N.

7. A method according to claim 6, wherein A is equal to the integer part of N/2 and B is equal to N−A.

8. A method according to claim 1, wherein N is an integer contained in the interval [7, 30].

9. A method according to claim 1, wherein N is an integer contained in the interval [10, 30].

10. A method according to claim 1, wherein N is an integer contained in the interval [13, 30].
